(19) United States
(12) Patent Application Publication
(10) Pub. No.: US 2014/0109775 A1
(43) Pub. Date: Apr. 24, 2014

(54) BARBECUE ROTARY DEVICE AND BARBECUE OVEN

(71) Applicant: MINGLE METAL (SHENZHEN)CO., LTD., Shenzhen (CN)

(72) Inventors: Waiming Ho, Shenzhen (CN); Mnig Lee, Shenzhen (CN)

(21) Appl. No.: 14/122,677

(22) PCT Filed: Jun. 30, 2011
(86) PCT No.: PCT/CN2011/076646

§ 371 Date: Nov. 27, 2013

(30) Foreign Application Priority Data
May 31, 2011 (CN) 201120180590.2

(51) Int. Cl. A47J 37/04; F16H 1/28

(52) U.S. Cl. CPC A47J 37/041; F16H 1/28
USPC 99/443 R; 74/411.5

(57) ABSTRACT

A barbecue oven and a barbecue rotary device are provided, wherein, the barbecue rotary device includes: a handgrip, a spring component for storing rotary energy, a main shaft component, and a gear set component for controlling the rotary speed of the main shaft component. The handgrip is connected with the rotary energy input end of the spring component, the main shaft component is connected with the rotary energy output end of the spring component, and the gear set component is connected to the main shaft component. Through the barbecue rotary device with the structure above described, the barbecue can be performed with less manual operation and without external power source.

The present application claims benefit of priority to Chinese Patent Application No. 201120180590.2, entitled “BARBECUE ROTATING DEVICE AND BARBECUE OVEN”, filed with the Chinese State Intellectual Property Office on May 31, 2011, the entire disclosure of which is incorporated herein by reference.

### TECHNICAL FIELD

The present application relates to the technical field of moulds, and particularly to a barbecue rotating device and a barbecue oven.

### BACKGROUND

A barbecue oven is a device for barbecue, which can be used for roasting various kinds of meat or other foods, Barbecue oven can be divided into a charcoal barbecue oven, a gas barbecue oven, an electric barbecue oven or a microwave barbecue oven.

When roasting the foods, it is necessary to frequently turn over the foods to heat the foods uniformly. When using a conventional barbecue device, such as a barbecue oven, it is required to turn over the foods manually, which is time consuming as well as energy consuming. Further, manual operation is apt to cause errors, such that the foods can not be uniformly heated and may be burnt. Or, when using a barbecue device with a motor, the foods are turned over under the action of the motor, however in this case an external power source is required which may limit the application and is not beneficial for energy saying and low-carbon lifestyles.

### SUMMARY

Embodiments of the present application provide a barbecue rotating device and a barbecue oven, by which during a roasting operation an external power source is not required and manual operation may be greatly reduced.

In order to solve the above technical problems, embodiments of the present application provide the following technical solutions.

A barbecue rotating device includes:

a handle, a clockwork component for storing rotation energy, a main shaft component, and a gear set component for controlling a rotation speed of the train shaft component;

wherein the handle is connected to a rotation energy input end of the clockwork component; the main shaft component is connected to a rotation energy output end of the clockwork component; and the gear set component is connected to the main shaft component.

Optionally, the clockwork component includes a clockwork case and a clockwork spring coiled in the clockwork case.

Optionally, the clockwork case is further provided with a ratchet wheel for controlling the clockwork spring to rotate in a single direction.

Optionally, the gear set component includes a transmission gear set, a ratchet wheel connected to the transmission gear set, an oscillating lever connected to the ratchet wheel, and an inertia wheel connected to the oscillating lever.

Optionally, the transmission gear set includes three secondary transmission gears.

Optionally, a transmission ratio of the transmission gear set is 1:12.

Optionally, the main shaft component includes a main shaft and a main shaft gear fixedly connected to the main shaft; and

the main shaft gear is engaged with the transmission gear set.

A barbecue oven includes:

a roasting stick, a barbecue bracket and a barbecue rotating device;

wherein the roasting stick and the barbecue rotating device are mounted on the barbecue bracket, and the barbecue rotating device is configured to drive the roasting stick to rotate; and

the barbecue rotating device includes a handle, a clockwork component for storing rotation energy, a main shaft component, and a gear set component for controlling a rotation speed of the main shaft component; wherein the handle is connected to a rotation energy input end of the clockwork component; the main shaft component is connected to a rotation energy output end of the clockwork component; and the gear set component is connected to the main shaft component.

Optionally, the clockwork component includes a clockwork case and a clockwork spring coiled in the clockwork case.

Thus, the barbecue rotating device arranged on the barbecue oven according to the embodiments of the present application includes a handle, a clockwork component for storing rotation energy, a main shaft component, and a gear set component for controlling the rotation speed of the main shaft component. The handle is connected to a rotation energy input end of the clockwork component, the main shaft component is connected to a rotation energy output end of the clockwork component, and the gear set component is connected to the main shaft component. Mechanical energy can be generated by rotating the handle for several circles so as to drive the roasting stick to rotate for a period of time. Thus, the barbecue rotating device according to the embodiment of the present application does not require power source, and has advantages of environmental protection, energy saving, low carbon and emission reduction.

Further, the transmission gear set may include three secondary transmission gears, and thus has a compact structure and is easy to be mounted on various barbecue ovens for use.

Further, in the barbecue rotating device, the clockwork component and the transmission gear set component are connected, thus energy stored in the clockwork spring can be released gradually, and it is not required to rotate the handle frequently. Hence, the operational process saves effort and is convenient. Furthermore, the transmission gear set is provided to reduce the rotation speed, which may make the rotation more uniformly and reliably.

Further, in the barbecue rotating device, the clockwork component and the transmission gear set component are connected to generate rotation at a constant speed or an approximately constant speed. Hence, a user can turn the handle by circles corresponding to the roasting times of various kinds of foods. Thus, the operational process is simple and convenient.

### BRIEF DESCRIPTION OF THE DRAWINGS

For more clearly illustrating embodiments of the present application, drawings referred to describe the embodiments will be briefly described hereinafter. Apparently, the drawings in the following description are only several embodiments of the present application, and for the person skilled in the art other drawings may be obtained based on these drawings without any creative efforts.

FIG. 1 is a schematic view showing the structure of a barbecue oven according to an embodiment of the present application;

FIG. 2 is a front schematic view of a barbecue rotating device according to an embodiment of the present application:

FIG. 3 is a side schematic view of a barbecue rotating device according to an embodiment of the present application; and

FIG. 4 is a sectional schematic view of a barbecue rotating device according to an embodiment of the present application taken along line A-A.

### DETAILED DESCRIPTION

Embodiments of the present application provide a barbecue rotating device and a barbecue oven so as to barbecue without an external power source and reduce manual operation as much as possible.

The technical solutions in the embodiments of the present application will be described clearly and completely hereinafter in conjunction with the drawings in the embodiments of the present application to make the objects, features, and advantages of the present application clearer and easier to understand. Apparently, the described embodiments are only a part of the embodiments of the present application, rather than all embodiments. Based on the embodiments in the present application, all of other embodiments, made by the person skilled in the art without any creative efforts, fall into the protection scope of the present application.

A detail description is as follows.

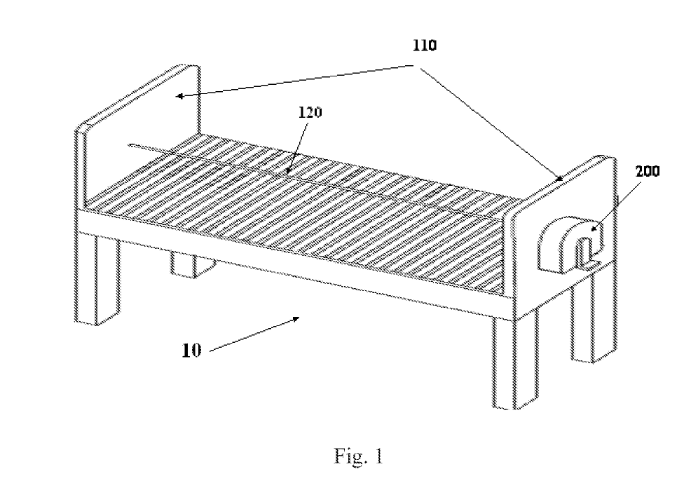

Reference is made to FIG. 1, which is a schematic view showing the structure of a barbecue oven according to an embodiment of the present application. Apparently, structural schematic views of similar barbecue ovens can be described by those skilled in the art on basis of the idea of the present application disclosed in FIG. 1.

As shown in FIG. 1, as an example, a barbecue oven 10 according to the present embodiment includes:

a roasting stick 120, a barbecue bracket 110 and a barbecue rotating device 200,

wherein, the roasting stick 120 (foods, such as meat, can be skewered on the roasting stick 120) and the barbecue rotating device 200 are mounted on the barbecue bracket 110, and the barbecue rotating device 200 drives the roasting stick 120 to rotate.

In a practical application, the barbecue rotating device 200 may drive the roasting stick 120 to rotate at a constant speed or an approximate constant speed (for example, the barbecue rotating device 200 may drive the roasting stick 120 to rotate at a constant speed or an approximate constant speed of 5 to 10 minutes per circle).

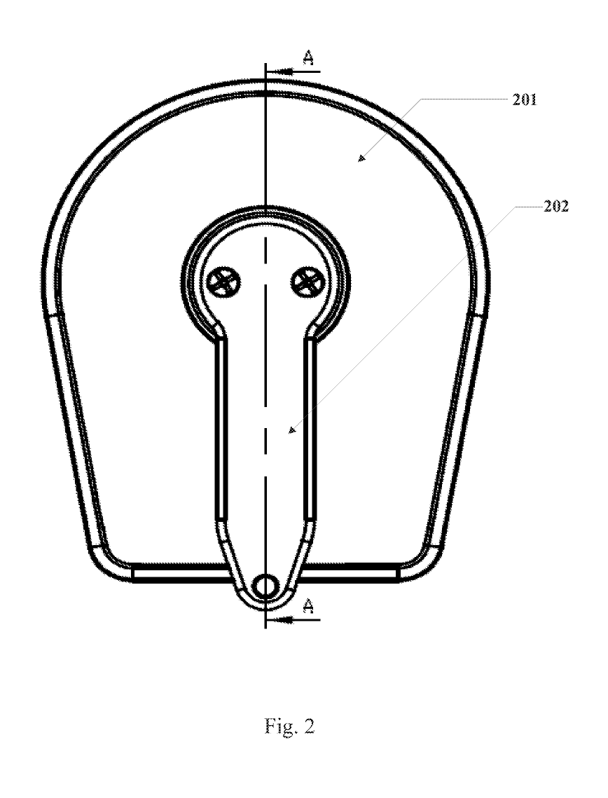

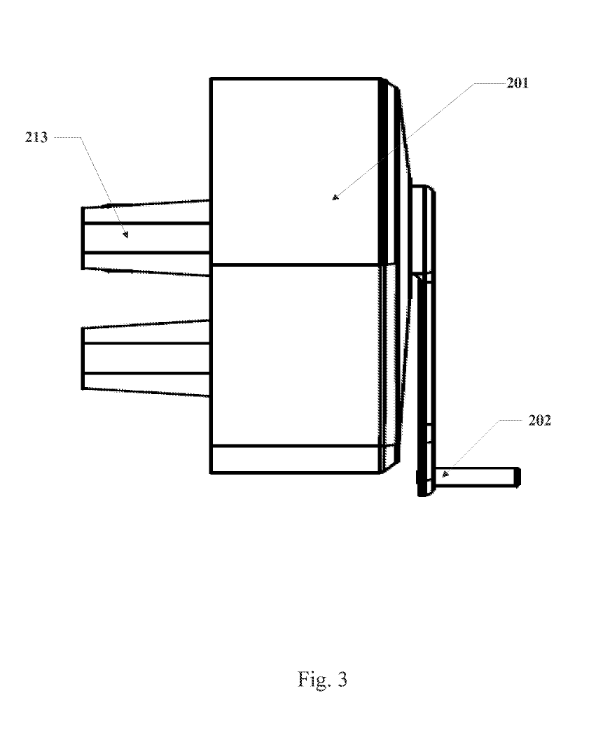

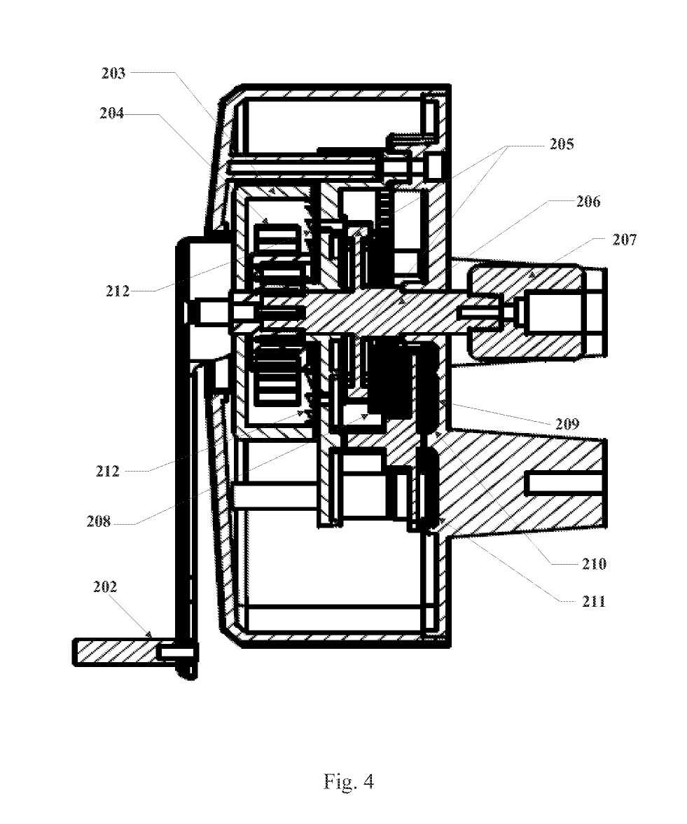

Reference is made to FIGS. 2 to 4, wherein FIG. 1 is a front schematic view of a barbecue rotating device according to an embodiment of the present application; FIG. 3 is a side schematic view of a barbecue rotating device according to an embodiment of the present application; and FIG. 4 is a sectional schematic view of a barbecue rotating device according to an embodiment of the present application taken along line A-A. Apparently, structural schematic views of similar barbecue ovens can be described by those skilled in the art on basis of the idea of the present application disclosed in FIGS. 2 to 4.

As shown in FIGS. 2 to 4, as an example, a barbecue rotating device 200 according to the present embodiment may include:

a handle 202, a clockwork component for storing rotation energy, a main shaft component, and a gear set component for controlling a rotation speed of the main shaft component. The handle 202 is connected to a rotation energy input end of the clockwork component. The main shaft component is connected to a rotation energy output end of the clockwork component. The gear set component is connected to the main shaft component.

The barbecue rotating device 200 may further include a housing 201, and the clockwork component, the main shaft component and the gear set component are mounted in the housing 201. Hence, the barbecue rotating device 200 may have a beautiful appearance, and it is also beneficial for effectively protecting the clockwork component, the main shaft component and the gear set component.

The barbecue rotating device 200 may further include a bracket column 213, and the barbecue rotating device 200 can be mounted on the barbecue bracket 110 via the bracket column 213.

The clockwork component 200 may include a clockwork case 203 and a clockwork spring 204 coiled in the clockwork case 203.

The handle 202 is connected to the clockwork case 203.

In addition, the clockwork case 203 may be further provided with a ratchet wheel 212 for controlling the clockwork spring 204 to rotate in a single direction. The ratchet wheel 212 may be arranged on an end surface of the clockwork case 203 to control the clockwork spring 204 to rotate in a single direction. Of course, the clockwork spring 204 can rotate in two directions in a case without the ratchet wheel 212.

The gear set component may include:

a transmission gear set 208, a ratchet wheel 209 connected to the transmission gear set 208, an oscillating lever 210 connected to the ratchet wheel 209, and an inertia wheel 211 connected to the oscillating lever 210.

In a practical application, the transmission gear set may include multiple secondary transmission gears. for example three secondary transmission gears, five secondary transmission gears, nine secondary transmission gears, or other number of secondary transmission gears. The transmission ratio of the transmission gear set may be 1:12, 1:16 or the like.

The main shaft component may include a main shaft 206 and a main shaft gear 205 fixedly connected to the main shaft 206.

The main shaft gear 205 is engaged with the transmission gear set 208.

The clockwork spring 204 has an outer circumference end connected to the clockwork case 203, and the other end connected to the main shaft 206.

Furthermore, the main shaft 206 may be further provided with a main shaft sleeve 207. One end of the roasting stick 120 can be inserted into the main shaft sleeve 207, such that the main shaft 206 may drive the roasting stick 120 to rotate. Apparently, the roasting stick 120 may also be fixedly connected to the main shaft 206 by bolts, welding or other tiers, so as to be driven by the main shaft 206 to rotate.

The operating principle of the overall barbecue oven 10 is described as follows.

The handle 202 is rotated to drive the clockwork component to work, and the clockwork component connected to the main shaft 206 transmits the rotation force to the main shaft 206. The main shaft gear 205 on the main shaft is engaged with the transmission gear set 208 of the gear set component, and the transmission gear set 208, the ratchet wheel 209, the oscillating lever 210 and the inertia wheel 211 of the gear set component are cooperated with each other to produce a reduction ratio. Under the action of the reduction ratio, the main shaft 206 rotating at a relatively higher speed is decelerated to rotate at a constant speed or an approximately constant speed. Then, the roasting stick 120 is driven by the main shaft 206 to rotate slowly at a constant speed or an approximately constant speed.

The handle 202 is connected to the clockwork case 203, and the clockwork spring 204 has an outer circumference end fixedly connected to the clockwork case 203 and the other end connected to the main shaft 206. When the handle is rotated, the rotation force is transmitted to the clockwork case 203, and the clockwork case 203 is rotated to drive the clockwork spring 204 to generate elastic deformation, thereby storing the rotation energy in the clockwork spring 204. When stopping rotating the handle 202, the rotation energy stored in the clockwork spring 204 is gradually released to drive the main shaft 206 to continue to rotate (generally, after being winded up, the clockwork spring 204 may drive the main shaft 206 to rotate for 30 to 90 minutes; and apparently, different types of clockwork springs may store different amounts of the rotation energy, thus the clockwork spring can be arranged as desired). Then, the roasting stick 120 driven by the main shaft 206 continues to rotate, and manual operation is not required in subsequent rotating process.

An embodiment of the present application further provides a barbecue rotating device. The barbecue rotating device may include a handle. a. clockwork component for storing rotation energy, a main shaft component and a gear set component for controlling the rotation speed of the main shaft component. The handle is connected to a rotation energy input end of the clockwork component; the main shaft component is connected to a rotation energy output end of the clockwork component; and the gear set component is connected to the main shaft component.

The barbecue rotating device may further include a. housing, and the clockwork component, the main shaft component and the gear set component are mounted in the housing. Hence, the barbecue rotating device may have a beautiful appearance, and it is also beneficial for effectively protecting the clockwork component, the main shaft component and the gear set component.

The barbecue rotating device may further include a bracket column, and the barbecue rotating device can be mounted on the barbecue bracket via the bracket column.

The clockwork component may include a clockwork case and a clockwork spring coiled in the clockwork case.

The handle is connected to the clockwork case.

In addition, the clockwork case may be further provided with a ratchet wheel for controlling the clockwork spring to rotate in a single direction. Of course, the clockwork spring can rotate in two directions in a case without the ratchet wheel.

The gear set component may include a transmission gear set, a ratchet wheel connected to the transmission gear set, an oscillating lever connected to the ratchet wheel, and an inertia Wheel connected to the oscillating lever.

In a practical application, the transmission gear set may include multiple secondary transmission gears, for example three secondary transmission gears, five secondary transmission gears, nine secondary transmission gears, or other number of secondary transmission gears. The transmission ratio of the transmission gear set may be 1:12, 1:16 or the like.

The main shall component may include a main shall and a main shall gear fixedly connected to the main shaft.

The main shaft gear is engaged with the transmission gear set.

The clockwork spring has an outer circumference end connected to the clockwork case and the other end connected to the main shaft.

Furthermore, the main shaft may be further provided with a main shaft sleeve. One end of the roasting stick can be inserted into the main shaft sleeve, such that the main shaft may drive the roasting stick to rotate. Apparently, the roasting stick may also be fixedly connected to the main shaft by bolts, welding or other manners, so as to be driven by the main shaft to rotate.

Thus, the barbecue rotating device arranged on the barbecue oven according to the embodiment of the present application includes a handle, a clockwork component for storing rotation energy, a main shaft component, and a gear set component for controlling the rotation speed of the main shaft component. The handle is connected to a rotation energy input end of the clockwork component, the main shah component is connected to a rotation energy output end of the clockwork component, and the gear set component is connected to the main shaft component. Mechanical energy can be generated by rotating the handle for several circles so as to drive the roasting stick to rotate for a period of time. Thus, the barbecue rotating device according to the embodiment of the present application does not require power source, and has advantages of environmental protection, energy saving, low carbon and emission reduction.

Further, the transmission gear set may include three secondary transmission gears, and thus has a compact structure and is easy to be mounted on various barbecue ovens for use.

Further, in the barbecue rotating device, the clockwork component and the transmission gear set component are connected, thus energy stored in the clockwork spring can be released gradually, and it is not required to rotate the handle frequently. Hence, the operational process saves effort and is convenient. Furthermore, the transmission gear set is provided to reduce the rotation speed, which may make the rotation more uniformly and reliably.

Further, in the barbecue rotating device, the clockwork component and the transmission gear set component are connected to generate rotation at a constant speed or an approximately constant speed. Hence, a user can turn the handle by circles corresponding to the roasting times of various kinds of foods. Thus, the operational process is simple and convenient.

Reference Numerals:

10 barbecue oven;

110 barbecue bracket;

20 roasting stick;

200 barbecue rotating device;

201 housing;

202 handle;

203 clockwork case;

204 clockwork spring;

205 main shaft gear;

206 main shaft;

207 main shaft sleeve;

208 transmission gear set;

209 ratchet wheel;

210 oscillating lever;

211 inertia wheel;

212 ratchet wheel; and

213 bracket column.

The barbecue rotating device and the barbecue oven according to the embodiments of the present application are described in detail hereinbefore. The principle and the embodiments of the present application are illustrated herein by specific examples, and the above description of examples is only intended to help the understanding of the method and the spirit of the present application. For the person skilled in the art, modifications may be made to the embodiments and application scope of the present application based on the spirit of the present application. in conclusion, the content of the present specification should not be interpreted as limitation to the present application.

1. A barbecue rotating device, comprising:
a handle, a clockwork component for storing rotation energy, a main shaft component, and a gear set component for controlling a rotation speed of the main shaft component;
wherein the handle is connected to a rotation energy input end of the clockwork component; the main shaft component is connected to a rotation energy output end of the clockwork component; and the gear set component is connected to the main shaft component.

2. The barbecue rotating device according to claim 1, wherein
the clockwork component comprises a clockwork case and a clockwork spring coiled in the clockwork case.

3. The barbecue rotating device according to claim 2, wherein
the clockwork case is further provided with a ratchet wheel for controlling the clockwork spring to rotate in a single direction.

4. The barbecue rotating device according to claim 1, wherein
the gear set component comprises a transmission gear set, a ratchet wheel connected to the transmission gear set, an oscillating lever connected to the ratchet wheel, and an inertia wheel connected to the oscillating lever.

5. The barbecue rotating device according to claim 4, wherein
the transmission gear set comprises three secondary transmission gears.

6. The barbecue rotating device according to claim 5, wherein
a transmission ratio of the transmission gear set is 1:12.

7. The barbecue rotating device according to claim 4, wherein
the main shaft component comprises a main shaft and a main shaft gear fixedly connected to the main shaft; and
the main shaft gear is engaged with the transmission gear set.

8. The barbecue rotating device according to claim 1, further comprising a housing;
wherein the clockwork component, the main shaft component and the gear set component are mounted in the housing.

9. A barbecue oven, comprising
a roasting stick, a barbecue bracket and a barbecue rotating device;
wherein the roasting stick and the barbecue rotating device are mounted on the barbecue bracket, and the barbecue rotating device is configured to drive the roasting stick to rotate; and
the barbecue rotating device comprises a handle, a clockwork component for storing rotation energy, a main shaft component, and a gear set component for controlling a rotation speed of the main shaft component; wherein the handle is connected to a rotation energy input end of the clockwork component; the main shaft component is connected to a rotation energy output end of the clockwork component; and the gear set component is connected to the main shaft component.

10. The barbecue oven according to claim 9, wherein
the clockwork component comprises a clockwork case and a clockwork spring coiled in the clockwork case.

11. The barbecue rotating device according to claim 5, wherein
the main shaft component comprises a main shaft and a main shaft gear fixedly connected to the main shaft; and
the main shaft gear is engaged with the transmission gear set.

12. The barbecue rotating device according to claim 6, wherein
the main shaft component comprises a main shaft and a main shaft gear fixedly connected to the main shaft; and
the main shaft gear is engaged with the transmission gear set.

13. The barbecue rotating device according to claim 2, further comprising a housing;
wherein the clockwork component, the main shaft component and the gear set component are mounted in the housing.

14. The barbecue rotating device according to claim 3, further comprising a housing;
wherein the clockwork component, the main shaft component and the gear set component are mounted in the housing.

15. The barbecue rotating device according to claim 4, further comprising a housing;
wherein the clockwork component, the main shaft component and the gear set component are mounted in the housing.

16. The barbecue rotating device according to claim 5, further comprising a housing;
wherein the clockwork component, the main shaft component and the gear set component are mounted in the housing.

17. The barbecue rotating device according to claim 6, further comprising a housing;
wherein the clockwork component, the main shaft component and the gear set component are mounted in the housing.
